(19) United States
(12) Patent Application Publication
(10) Pub. No.: US 2010/0064960 A1
(43) Pub. Date: Mar. 18, 2010

(54) GOLF BAG

(76) Inventors: Stephan Wolf BERNDT, Craighall (ZA); Richard MICHELMORE, Craighall (ZA)

Correspondence Address: YOUNG & THOMPSON, 209 Madison Street, Suite 500, Alexandria, VA, 22314, US

(21) Appl. No.: 12/551,771

(22) Filed: Sep. 1, 2009

(30) Foreign Application Priority Data
Sep. 13, 2008 (ZA) 2008/04116

(51) Int. Cl. G09F 17/00

(52) U.S. Cl. 116/173

(57) ABSTRACT

A golf flag includes at least two zones, one being substantially rigid to receive and display advertising matter, and the other is flexible to indicate wind direction and strength.

### FIELD OF THE INVENTION

This invention relates to flags and in particular to golf flag.

### BACKGROUND OF THE INVENTION

Flags and banners have become an important part of the advertising aspect of modern life; and there have even been moves to apply advertising material to the somewhat staid golf flag.

Whereas the invention is essentially directed to golf flags it will be appreciated that it may also be applied to other flags and banners.

Several prior art inventions relating to golf flags have been located in a patent search, such as JP2003126316 (Kurodo Takuya) in the form of a flag body with a name entry column for competitions. This column may be overlaid with a sticking label that is removable after a tournament. Another Japanese patent in the name of Kukida Kazuhiyto (2006208627) that presents different colours corresponding to predetermined wind speeds and U.S. Pat. No. 4,558,862 is in the form of a wind sock that exaggerates the force of a wind.

No patents were found that suggest adaptation for advertising purposes although the applicants are aware of a pin for a golf flag in which the pin has an attachment adapted to receive advertising.

It is an object of the present invention to provide a flag for advertising purposes.

Another object of the invention is to provide a flag that is adapted to receive advertising material and that is also capable of indicating wind.

### THE INVENTION

According to the invention a flag adapted to be fitted rotatably to a pin includes at least one zone for receiving advertising material.

In a preferred form of the invention a flag includes a zone for receiving advertising material and a flexible zone adapted to indicate wind strength and direction.

A flag according to the invention may be divided into a top and a bottom half, the former being adapted to receive advertising material and the latter to be flexible to indicate wind direction and speed. Thus, the former may be substantially rigid so the advertising material is easily applied and easily observed and the latter is flexible and serves to assist rotation of the flag according to the direction of wind and to give an indication of the strength of the wind.

In one form of the invention the flag is divided by a diagonal line separating the rigid from the flexible zone. The rigid zone preferably constitutes the top zone and may be manufactured from a metallic, plastic or other rigid or semi-rigid material whereas the lower zone is made from a suitable flexible fabric.

In a refinement of the invention the sleeve of the flag has a larger diameter than the pin so that it can be used to accommodate vertical advertising material.

The flag may be attached to the pin by any of a number of means such as that described in US2005066561 or GB171947, but in a preferred form of the invention the flag is attached by means of a dagger board to a sleeve member rotatable on the pin.

### EMBODIMENTS OF THE INVENTION

Embodiments of the invention are illustrated in the accompanying drawings.

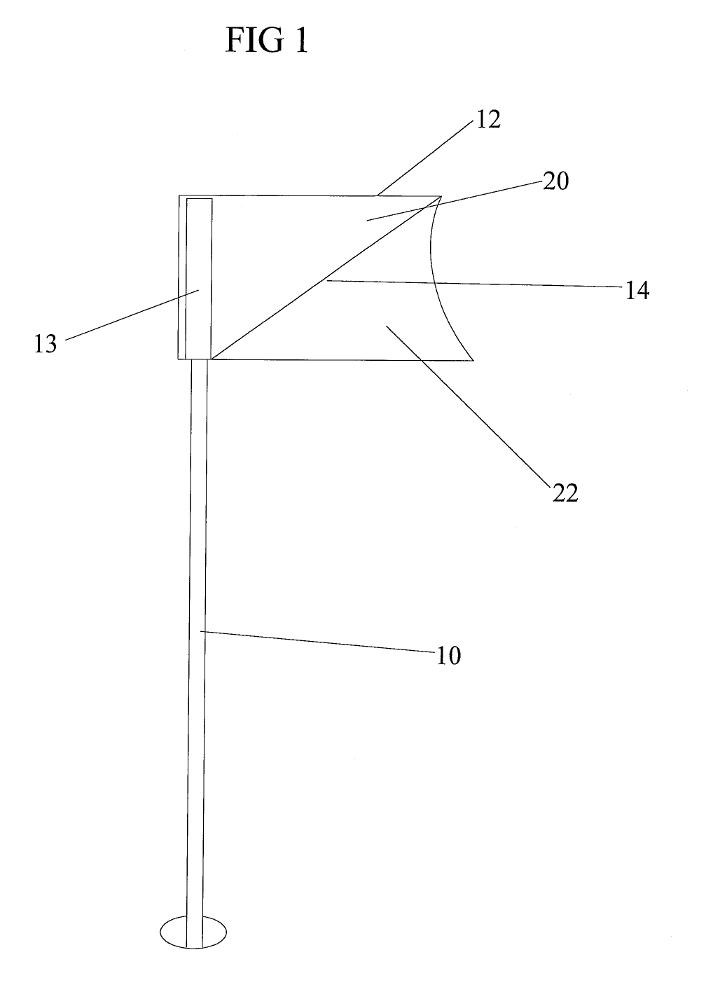

In FIG. 1 a pin 10 is similar to a conventional golf flag pin and it carries a flag 12 that is joined to a sleeve 13, the sleeve being freely rotatable about the pin. The zone of the pin towards the top is of a large diameter so that that vertical advertising may be applied.

The flag is divided into two zones by means of a diagonal line 14 but it will be appreciated that the zones may have different shapes and positions.

The zone 20 above the diagonal may be made from a rigid or semi-rigid material or may be a fabric stiffened with rods or the like or is treated with a stiffening composition such as a settable polymeric composition. The lower zone 22 is a flexible fabric which could be the same as the top zone but without stiffening.

The flag is mounted on the sleeve by any suitable means, such by means of a dagger board (not shown) that fits into the sleeve.

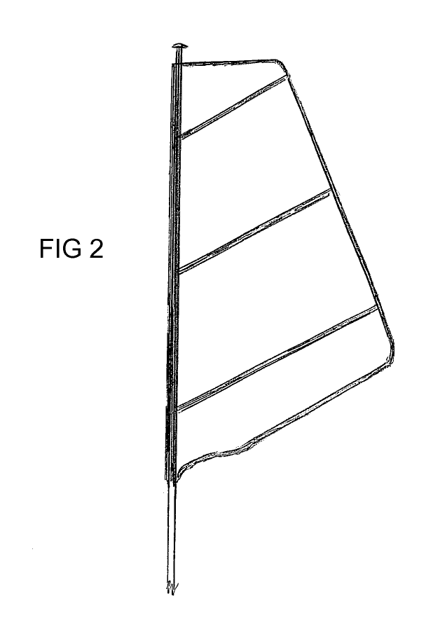

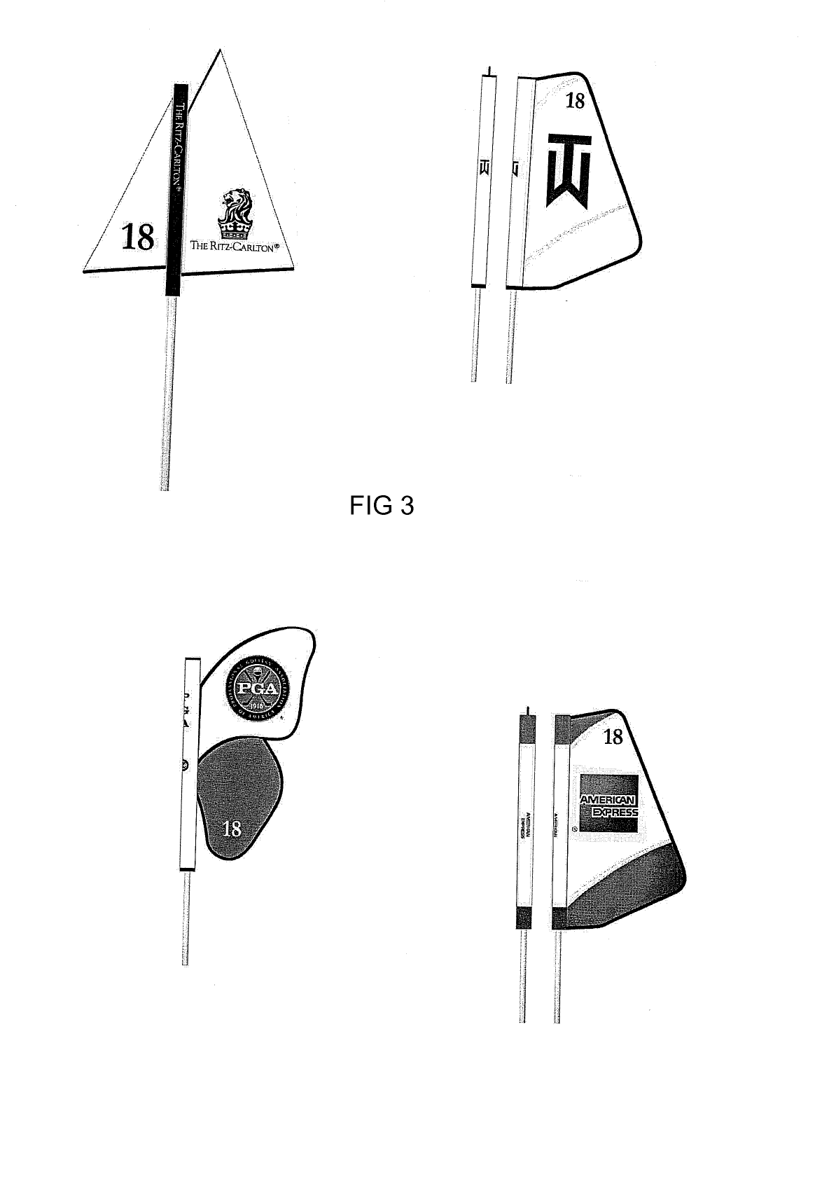

As shown in the drawing the flag has a sail shape and it will be appreciated that many other sail shapes are also included within the scope of the invention. For example in FIG. 2 another possible shape is indicated and which includes a number of zones for advertising matter, and the lowermost zone being the wind indicator zone. It will be appreciated that the number of variations in shape and configuration are almost infinite and four of the many possibilities are shown as FIG. 3.

It will be appreciated that the flag itself, the material from which it is manufactured, the diameter of the top portion and other features are approved by the rules of golf and authorized by the Royal and Ancient Club.

1. A flag adapted to be fitted rotatably to a pin including at least one first zone for receiving advertising material and a second flexible zone adapted to indicate wind strength and direction, the first zone being more rigid than the flexible zone.

2. The flag according to claim 1 which is divided into a top and a bottom half, the former being more rigid than the latter so the advertising material is easily applied and easily observed and the latter is flexible and serves to assist rotation of the flag according to the direction of wind and to give an indication of the strength of the wind.

3. The flag according to claim 1 which is divided by a diagonal line separating the rigid from the flexible zone.

4. The flag according to claim 1 which has a sleeve of larger diameter than the pin so that it can be used to accommodate vertical advertising material.

5. The flag according to claim 4 in which the flag is attached to the sleeve by means of a dagger board arrangement.

6. The flag according to claim 1 having a sail shape.
